(19) United States
(12) Patent Application Publication
(10) Pub. No.: US 2018/0270387 A1
(43) Pub. Date: Sep. 20, 2018

(54) PRINTING APPARATUS, SERVER, PRINTING METHOD, AND CONTROL METHOD

(71) Applicant: SEIKO EPSON CORPORATION, Tokyo (JP)

(72) Inventor: Yasuhiro FURUTA, Shimosuwa (JP)

(21) Appl. No.: 15/913,281

(22) Filed: Mar. 6, 2018

(30) Foreign Application Priority Data
Mar. 16, 2017 (JP) 2017-051771

(51) Int. Cl. H04N 1/23; G06F 3/12

(52) U.S. Cl. CPC H04N 1/2346; G06F 3/1294; G06F 3/1208; G06F 3/1259; H04N 1/2323

(57) ABSTRACT

A printing apparatus includes: a storage unit that stores print data generated by a method other than reading of a print; and a print processing unit that prints, on the single printing medium, the stored print data and identification information used for identifying the print data, and when the identification information from read data obtained by reading a print is detected, the print processing unit prints the print data stored in the storage unit and identified by the detected identification information.

### BACKGROUND

### 1. Technical Field

The present invention relates to a printing apparatus, a server for controlling a printing apparatus, a printing method, and a control method for controlling a server.

### 2. Related Art

A printer prints read data obtained by reading a document, that is, a printer copies a document.

The related art discloses a document management apparatus that extracts and manages, as electronic image data, a part of a document to which handwriting has been added, forms a combined image of user-selected image data to be managed, and prints the combined image on an output medium (see, for example, JP-A-2007-325196).

In copying a document, there is a problem of quality deterioration compared to the original document, because the copied document is a print of read data representing the original document. Further, in the above related art, since the original document data under management is data obtained by scanning and saving the original document, the quality thereof has already deteriorated at the printing of the original document data.

### SUMMARY

An advantage of the invention is to provide a printing apparatus, a server, and the like that improve copy quality.

A printing apparatus according to the first aspect of the invention includes a storage unit that stores print data generated by a method other than reading of a print; and a print processing unit that prints, on a single print medium, the stored print data and identification information used for identifying the print data, and when the identification information from read data obtained by reading a print is detected, the print processing unit prints the print data stored in the storage unit and identified by the detected identification information.

According to the above configuration, once a print with the printed identification information is scanned for copying the print, the identification information is detected from the read data generated by the scan, and print data identified by the identification information (print data generated by a method other than reading of a print) is read from the storage unit and printed. Therefore, a user can obtain a print without quality deterioration as a copy result.

In this case, the print processing unit may print, on a single printing medium, the print data which is stored in the storage unit and identified by the detected identification information and data which is not included in the print data but is included in the read data.

According to the above configuration, when a print in which a handwritten text or the like is added is scanned for copying the print, the print data stored in the storage unit and the added part (data which is not included in the print data but is included in the read data) are combined and printed. Therefore, the quality of a copy result including the added part is improved.

In this case, the print data stored in the storage unit may be formed of print page data that is data of each page, and the print processing unit may print, on a single printing medium, the print page data and identification information used for identifying the print page data and, when identification information used for identifying the print page data from the read data is detected, may generate new print data in accordance with print page data identified by the detected identification information out of print page data of the print data stored in the storage unit and prints the generated print data.

According to the above configuration, when a user scans prints after selection or rearrangement, new print data is generated as described above, and the generated print data is printed as a copy result. Thus, a user can obtain an intended copy result at a high quality.

In this case, the print page data of the print data stored in the storage unit may contain information defining an association with another print page data of the print data, and, when identification information identifying the print page data from the read data obtained by reading multiple pages of prints, the print processing unit may generate as the new print data, out of the print page data of the print data, print page data which contains information defining an association with print page data from which the identification information is detected and does not contain information defining an association with print page data from which the identification information is not detected.

According to the above configuration, the printing apparatus can generate print data that does not contain unnecessary information when generating the print data as described above.

In this case, the print processing unit may print, on a single printing medium, the generated print data and identification information used for identifying the generated print data.

According to the above configuration, when a print result of the generated print data is again copied, the print data can be printed in accordance with the identification information. That is, the quality is not deteriorated even with repetition of copying.

In this case, the print processing unit may store the generated print data in the storage unit.

According to the above configuration, a scan result of a print can be saved as an electronic file. Further, such print data (electronic file) can be transferred to the outside.

The technical concept of the invention may be implemented in various forms other than the category of a printing apparatus. For example, the invention may be a server including a storage unit that stores print data generated by a method other than reading of a print; and a print control unit that causes a printing apparatus to perform a process of printing, on a single printing medium, the stored print data and identification information used for identifying the print data, and when the identification information from read data obtained by reading a print is detected, the print control unit causes the printing apparatus to print the print data stored in the storage unit and identified by the detected identification information.

Further, the invention may apply to a system including a server and a printing apparatus. Furthermore, the invention may apply to steps (method) executed by each of a server and a printing apparatus, a program that causes hardware (computer) to execute such methods, and a computer readable storage medium storing a program therein, respectively.

### BRIEF DESCRIPTION OF THE DRAWINGS

The invention will be described with reference to the accompanying drawings, wherein like numbers reference like elements.

FIG. 1 is a diagram schematically illustrating a system configuration.

FIG. 2 is a flowchart illustrating a print control process.

FIG. 3 is a diagram illustrating files and pages of respective files as print data.

FIG. 4 is a flowchart illustrating a copy control process.

FIG. 5 is a diagram illustrating a copy process in accordance with a specific example.

FIG. 6 is a flowchart illustrating the details of step S210.

### DESCRIPTION OF EXEMPLARY EMBODIMENT

An embodiment of the invention will be described below with reference to the drawings. Note that each drawing is a mere example for illustrating the embodiment.

### 1. General Description of System

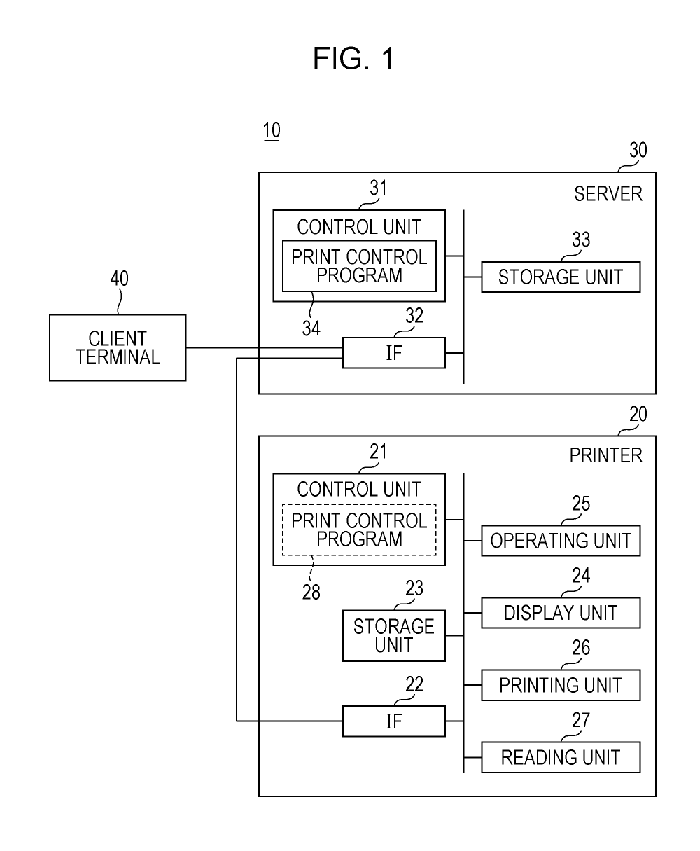

FIG. 1 schematically illustrates a system 10 according to the present embodiment. The system 10 includes one or more printers 20 as a printing apparatus, and a server 30. Further, the system 10 may include one or more client terminals 40. A printer refers to an apparatus that functions as at least a printer. The printer 20 may be a stationary printer or may be a portable compact printer (mobile printer). The printer 20 may be referred to as an image forming apparatus.

The printer 20 includes a control unit 21, a communication interface (IF) 22, a storage unit 23, a display unit 24, an operating unit 25, a printing unit 26, a reading unit 27(a scanning unit 27), and the like, for example. The control unit 21 may be formed of one or a plurality of ICs having a CPU, a ROM, a RAM, or the like, other memory devices, or the like, for example. In the control unit 21, the CPU controls actions of each unit of the printer 20 such as the printing unit 26 by using the RAM or the like as a work area to execute an operation process in accordance with firmware or a program stored in the ROM or the like.

The communication IF 22 is a general IF that conforms with a predetermined communication standard and performs external communication. The storage unit 23 is formed of a storage device such as a hard disk drive or a flash memory or formed of a part of the control unit 21. The display unit 24 is a unit adapted to display visual information and is formed of a liquid crystal display (LCD), an organic EL display, or the like, for example. The display unit 24 may have a configuration including a display and a drive circuit for driving the display. The operating unit 25 is a unit adapted to enable input of user operations and is implemented as a touch panel, a physical button, a keyboard, or the like, for example. The display unit 24 may of course also function as such a touch panel. The display unit 24 and the operating unit 25 may be collectively referred to as an operating panel.

The printing unit 26 is a mechanism that performs printing in accordance with print data on a printing medium and, for example, performs printing by using an ink jet scheme. A printing medium is represented by a sheet, but a material other than paper may be employed as a printing medium provided that the material can be used for printing. Note that the printing scheme employed by the printing unit 26 is not limited to an ink jet scheme, but various schemes such as an electronic photograph scheme may be employed. Since the configuration of the printing unit 26 is well known, detailed description thereof will be omitted.

The reading unit 27 is a mechanism that functions as a scanner and generates image data (read data) by optically reading a document. The printer 20 having the reading unit 27 may be referred to as a multi-function printer, a copy machine, or the like. However, the reading unit 27 may be a scanner connected to the printer 20 rather than a part of the printer 20.

The server 30 includes a control unit 31, the communication IF 32, a storage unit 33, or the like, for example. The server 30 may be implemented as one or a plurality of information processing devices that function as a server. The control unit 31 may be formed of one or a plurality of ICs having a CPU, a ROM, a RAM, or the like, other memory devices, or the like, for example. In the control unit 31, the CPU controls actions of the server 30 by using the RAM or the like as a work area to execute an operating process in accordance with a program stored in the ROM or the like. A print control program 34 as a type of a program is installed in the control unit 31. The server 30 may be referred to as a print control device. The description of the communication IF 22 and the storage unit 23 may also be applied as a basic description of the communication IF 32 and the storage unit 33.

The client terminal 40 may be implemented as a personal computer (PC), a smartphone, a tablet terminal, a mobile phone, or other communication terminals, for example.

The form or the standard of communication between the devices illustrated in FIG. 1 is not limited in particular. For example, the client terminal 40 or the printer 20 communicates with the server 30 via a network (a network that may include a local area network (LAN) or the Internet). The network may be a wired network or a wireless network.

### 2. Print Process

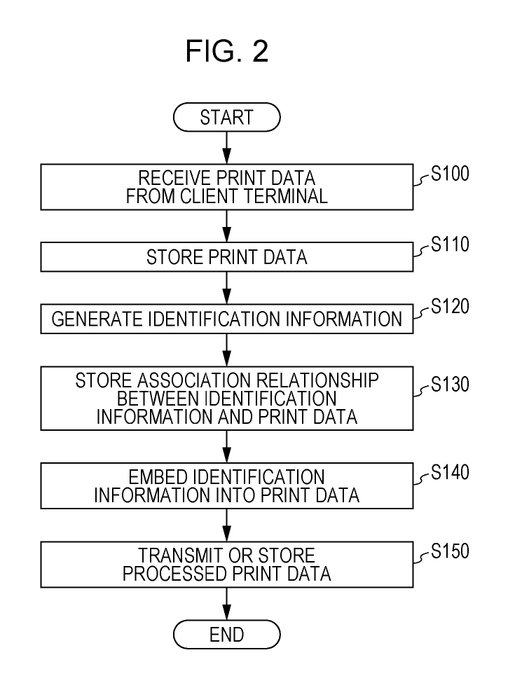

FIG. 2 illustrates a print control process performed by the control unit 31 of the server 30 in accordance with the print control program 34 with reference to a flowchart.

The control unit 31 receives print data from the client terminal 40 (step S100). The print data is a type of file that represents content to be printed (content including text, photographic images, illustrations, or the like). The client terminal 40 generates print data by using a function of an application program for generating contents (for example, a document creation program) in accordance with user operation and transmits the generated print data to the server 30 that causes the printer 20 to print the generated print data.

The control unit 31 stores the received print data in the storage unit 33 (step S110). Note that, when held in the server 30, print data is not required to be data of a format that can be interpreted by the printing unit 26 of the printer 20 in execution of printing (for example, data in a Page Description Language (PDL) format or dot data defining on/off of a dot for each ink color). Accordingly, print data transmitted from the client terminal 40 and stored in the server 30 is not limited to data that is generated by reading a print (scanning a document). That is, print data transmitted from the client terminal 40 and stored in the server 30 may be print data that is generated by a method other than reading of a print.

Next, the control unit 31 generates identification information used for identifying the print data stored as described above (step S120). The term “identification information” here denotes information used for identifying print data on a per-page basis.

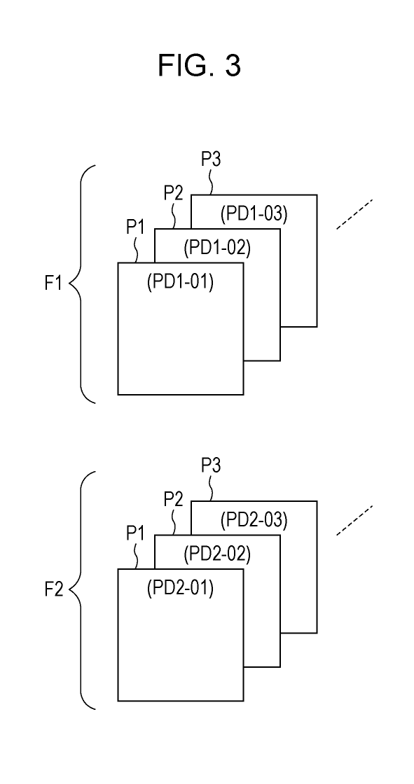

For example, assume that the control unit 31 receives, from the client terminal 40, and stores a file F1 and a file F2 as print data (see FIG. 3). In the example of FIG. 3, each of the files F1 and F2 has corresponding data (print page data) of a first page (P1), a second page (P2), a third page (P3), . . . , and so on. Therefore, the control unit 31 generates unique identification information for the corresponding print data of each page.

There are various methods for generating identification information. For example, the control unit 31 generates required identification information by using or combining information specific to the client terminal 40 that is a source of the print data (a serial number or the like), information which can be easily acquired such as the current date and time or the like, a random number, or the like. In this example, the control unit 31 generates identification information of PD1-01, PD1-02, PD1-03, . . . , and so on in association with the first page (P1), the second page (P2), the third page (P3), . . . , and so on of the file Fl and generates identification information of PD2-01, PD2-02, PD2-03, . . . , and so on in association with the first page (P1), the second page (P2), the third page (P3), . . . , and so on of the file F2.

The control unit 31 stores, in the storage unit 33, the association relationship between the generated identification information and print data, that is, the association relationship between each page of print data and the identification information, as for example, a table describing the association relationship (step S130).

Furthermore, the control unit 31 embeds the generated identification information in the print data (step S140). In this case, the control unit 31 embeds associated identification information in data of each page of the print data. There are various conceivable ways of embedding identification information. For example, the control unit 31 embeds identification information in data of an associated page by using a so-called electronic watermark scheme. Alternatively, the control unit 31 may combine a barcode representing identification information (a two-dimensional barcode is possible) to data of the associated page. In FIG. 3, identification information embedded in each page is illustrated in parentheses as an example in each of the pages P1, P2, P3, . . . , and so on of the files F1 and F2. FIG. 3 illustrates text information (identification information) that is understandable to a human, such as PD1-01, PD1-02, PD1-03, . . . , and so on, in a visible manner for easier understanding, but in the actual implementation, the identification information embedded in each page of print data in a form of an electronic watermark, a barcode, or the like.

Next, the control unit 31 transmits to the printer 20 or stores therein the processed print data, that is, print data in which identification information is embedded as described above (step S150). There are two main types of printing methods used by the system 10, one of which is a push-type printing method, and the other of which is a pull-type printing method.

In the push-type printing method, when transmitting print data to the server 30, the client terminal 40 also transmits printer designation information that designates the printer 20 to perform printing. The server 30 transmits the processed print data to the printer 20 designated by the printer designation information in step S150. The printer 20 receives the print data transmitted from the server 30 and performs printing in accordance with the print data.

In the pull-type printing method, no printer designation information is received from the client terminal 40 in particular, and the server 30 temporarily stores the processed print data (step S150). A user may operate the printer 20 to transmit a print data request from the printer 20 to the server 30. Upon receiving the request, the server 30 transmits the stored processed print data to the printer 20 which is the source of the request. The printer 20 receives the print data transmitted from the server 30 in response to its request and performs printing in accordance with the print data.

During printing in accordance with print data, the control unit 21 of the printer 20 can perform various image conversion processes such as a resolution conversion process, a color conversion process, or a halftone process on print data to obtain print data in a format that can be interpreted by the printing unit 26 and can cause the printing unit 26 to perform printing in accordance with the print data. Such image conversion processes may be performed before the control unit 31 of the server 30 transmits print data to the printer 20.

Identification information is embedded in print data transmitted to the printer 20 from the server 30 as described above. Thus, print data (content represented by print data) and identification information (electronic watermark, barcode, or the like) are printed on the same printing medium by the printer 20. Therefore, the control unit 21 and the printing unit 26 of the printer 20 function as a print processing unit that prints, on the same printing medium, print data generated by a method other than reading of a print and identification information used for identifying the print data. Further, the server 30 includes the storage unit 33 that stores print data generated by a method other than reading of a print and a print control unit (control unit 31) that causes the printer 20 to perform printing of the stored print data and the identification information used for identifying the print data on the same printing medium.

### 3. Copy Process

Next, a copy process in the present embodiment will be described. In order to copy a print output by the printer 20, a user causes the reading unit 27 to scan the print (document). At this time, the user may cause the printer 20 to scan documents in a rearranged order, scan a plurality of mixed documents, scan only some documents, or scan a document to which a handwritten document or the like has been added. The control unit 21 of the printer 20 transmits, to the server 30, read data(scanned data) generated by the reading unit 27 reading a document.

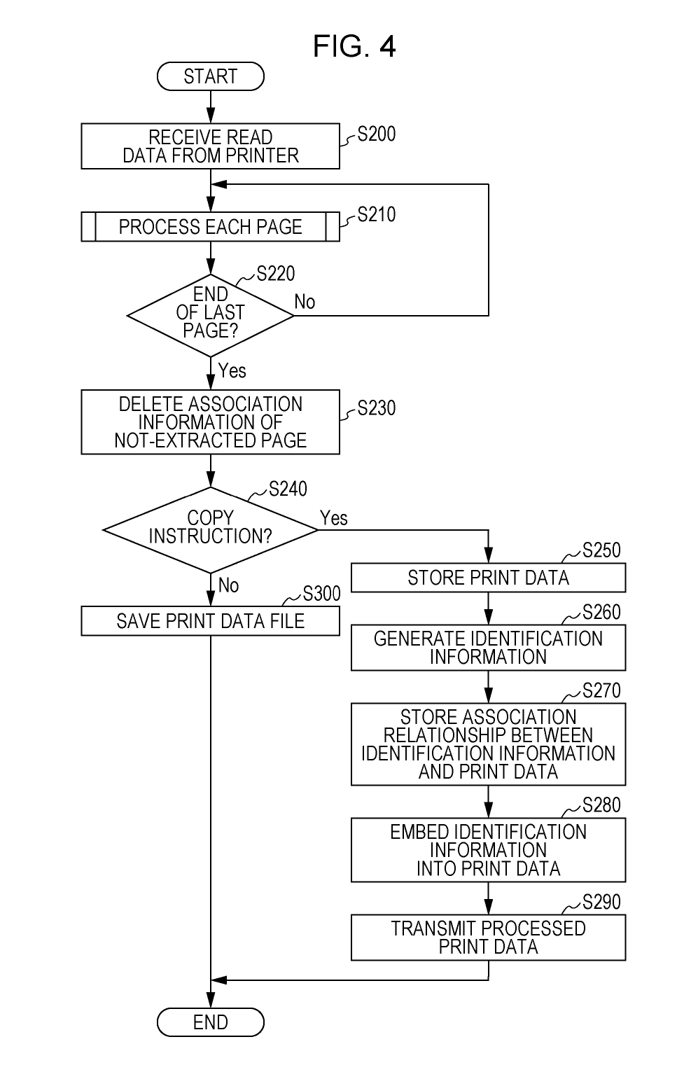

FIG. 4 illustrates a copy control process performed by the control unit 31 of the server 30 in accordance with the print control program 34 and using a flowchart.

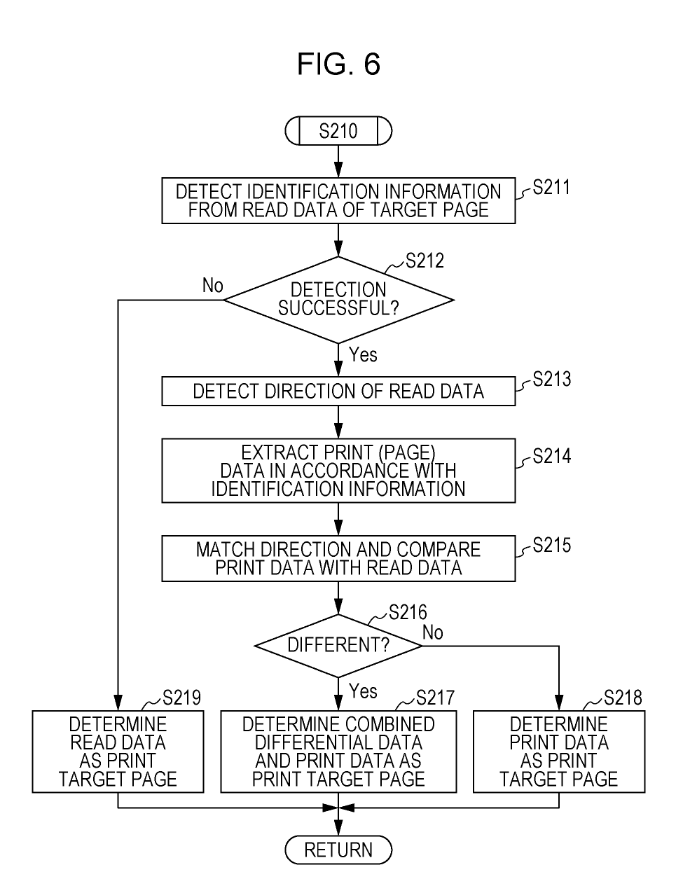

The control unit 31 receives read data transmitted from the printer 20 (step S200) and, in response to the reception, performs a process for each page of read data (step S210). The process for each page (step S210) will be described later in detail by using FIG. 6. When a user causes the reading unit 27 to scan N pages of documents, read data formed as data for N pages is transmitted to the server 30. The control unit 31 sequentially determines each page of the read data received in step S200 as a target page and repeats step S210, and upon determination of the final page (the N-th page) of the read data as the target page and the completion of step S210, “Yes” is determined in step S220, and the process proceeds to step S230.

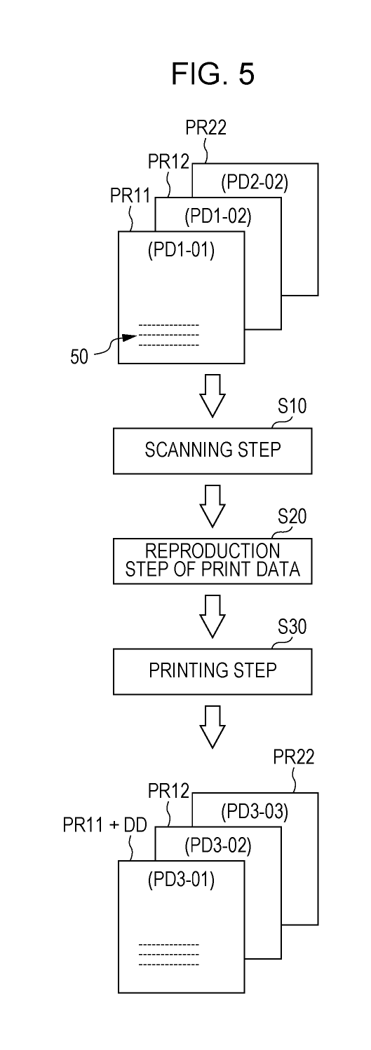

FIG. 5 is a diagram illustrating flow of the copy process in accordance with a specific example. In the upper part in FIG. 5, prints PR11, PR12, and PR22 of the prints output from the printer 20 through “2. Print Process” described above are depicted. The print PR11 is a print result of the first page (P1) of the file F1 illustrated in FIG. 3. In the prints PR11, however, a handwritten character string 50 has been added by a user. Further, the print PR12 is a print result of the second page (P2) of the file F1 illustrated in FIG. 3, and the print PR22 is a print result of the second page (P2) of the file F2 illustrated in FIG. 3. FIG. 5 illustrates identification information PD1-01, PD1-02, and PD2-02 included as a part of respective print results within the prints PR11, PR12, and PR22 in a visible manner similarly to FIG. 3 for easier understanding. In the actual implementation, however, the identification information PD1-01, PD1-02, and PD2-02 is printed in a form of an electronic watermark, a barcode, or the like on the printing medium.

In the example of FIG. 5, assume that a user has caused the reading unit 27 to read three prints PR11, PR12, and PR22 as documents. That is, the prints PR11, PR12, and PR22 are scanned by the reading unit 27 (scanning step (step S10)), read data of the prints PR11, PR12, and PR22 is transmitted to the server 30 from the printer 20. Then, in accordance with the read data of the prints PR11, PR12, and PR22, a print data reproduction step (step S20) is performed by the server 30. The process illustrated in FIG. 4 (all of the operations except for step S300) corresponds to the print data reproduction step.

FIG. 6 illustrates details of step S210 (FIG. 4) with reference to a flowchart.

The control unit 31 detects identification information from read data of the current target page, for example, the prints PR11 (step S211). In this case, the control unit 31 attempts to restore identification information from embedded information (an electronic watermark, a barcode, or the like) by analyzing data within a page by using a predetermined analysis method.

In the control unit 31, if the detection of identification information in step S211 is successful, “Yes” is determined in step S212, and the process proceeds to step S213. On the other hand, if the detection of identification information in step S211 is not successful, “No” is determined in step S212, and the process proceeds to step S219. The fact that identification information is not detected from read data of a target page means that a general document in which no identification information is embedded is scanned. Therefore, the control unit 31 recognizes the read data of the target page as “print target page” in step S219, ends current step S210, and proceeds to determination in step S220 (FIG. 4).

On the other hand, in step S213, the control unit 31 determines the direction (vertical direction) of read data of the target page. This is because a user may place documents in various directions when setting the document on the scanner (the reading unit 27). The control unit 31 determines the direction of read data by performing image analysis or the like on the read data.

In step S214, the control unit 31 extracts print data of one page (print page data) from the storage unit 33 in accordance with the identification information detected in step S211. As described above, since the storage unit 33 stores association relationship between each page of each print data and identification information, identification information detected in step S211 and the association relationship are referenced, and the print data identified by the identification information is extracted. For example, when the current target page is the read data of the print PR11, the identification information PD1-01 is detected from the read data (steps 5211 and S211). As a result, in step S214, data of the first page (P1) of the file F1 associated with the identification information PD1-01 is extracted from the storage unit 33.

In step S215, the control unit 31 compares an image of the read data of the target page with an image of the print data (print page data) extracted in step S214 after matching the directions thereof and detects a difference thereof. As described above, the handwritten character string 50 is added by a user on the print PR11, and the print PR11 is then scanned. Therefore, when the current target page is the read data of the print PR11, the image of the handwritten character string 50 is detected as a difference as a result of comparison in step S215. If a difference is detected as a result of comparison in step S215, the control unit 31 determines “Yes” in step S216 and proceeds to step S217. On the other hand, if no difference is detected as a result of comparison in step S215, the control unit 31 determines “No” in step S216 and proceeds to step S218.

The control unit 31 combines the difference (differential data) detected through the comparison in step S215 to the print data (print page data) extracted in step S214 and recognizes the combined data as “print target page”. The control unit 31 then ends the current step S210 and proceeds to determination in step S220 (FIG. 4).

On the other hand, in step S218, the control unit 31 recognizes print data (print page data) extracted in step S214 as “print target page”, ends the current step S210, and proceeds to determination in step S220 (FIG. 4).

FIG. 4 is again referenced.

In step S230, the control unit 31 deletes information related to not-extracted page of the data of respective pages which are recognized as print target pages in step S210. The not-extracted page refers to print page data stored in the storage unit 33 other than print page data extracted in step S214 of FIG. 6. According to the example of FIG. 5, three prints PR11, PR12, and PR22 are scanned, and step S210 is performed with respective read data of these prints PR11, PR12, and PR22 being determined as target data. Therefore, in step S214 of step S210 that is repeated for three times, data of the first page (P1) of the file Fl, data of the second page (P2) of the file F1, and data of the second page (P2) of the file F2 are extracted, and data of the third page (P3) of the file F1, data of the first page (P1) of the file F2, and data of the third page (P3) of the file F2, which are not extracted, correspond to not-extracted pages.

A plurality of pages of a file may originally have information defining mutual association (association information). For example, data of the first page (P1) of the file F1 may have information of a cross-reference used for linking some description within a page to the second page (P2) of the same file F1 or a cross-reference used for linking another description within the page to the third page (P3) of the same file F1. According to the example described above, while data of the first page (P1) and data of the second page (P2) of the file F1 are extracted in step S214, data of the third page (P3) of the file F1 is of a not-extracted page. Thus, the cross-reference used for linking the first page (P1) of the file F1 to the second page (P2) of the file F1 corresponds to association information of an extracted page. However, the cross-reference used for linking the first page (P1) of the file F1 to the third page (P3) of the file F1 corresponds to association information of a not-extracted page and is to be deleted. The cross-reference is a mere example of association information of a not-extracted page.

In step S240, the control unit 31 branches the process in accordance with whether or not a copy instruction is received from the printer 20. The user of the printer 20 can operate the operating unit 25 to instruct to copy a document or save a file when causing the reading unit 27 to scan the document. The control unit 21 of the printer 20 transmits a copy instruction or a file-save instruction from the user to the server 30 together with read data of the document. Therefore, when receiving a copy instruction together with read data from the printer 20 in step S200, the control unit 31 determines “Yes” in step S240 and proceeds to step S250. On the other hand, when receiving a file-save instruction together with read data, the control unit 31 determines “No” in step S240 and proceeds to step S300.

In step S300, the control unit 31 combines print target pages recognized in respective steps 5210 repeated for respective target pages to create new print data and saves (stores in the storage unit 33) the new print data in a predetermined file form. The user may operate the client terminal 40 to download the print data saved as described above to the client terminal 40 from the server 30, for example.

Alternatively, the control unit 31 may receive a file-transfer instruction as a type of the file-save instruction described above together with read data from the printer 20. In this case, in step S300, the new print data described above is transferred to the destination (for example, a folder within a storage area of the client terminal 40) indicated by the file-transfer instruction.

In step S250, the control unit 31 stores in the storage unit 33 the print data formed of print target pages recognized in respective steps S210 repeated for respective target pages. The print data stored in such a way (alternatively, saved in step S300) is newly generated print data obtained by rearranging print page data already stored in the storage unit 33, extracting and gathering some of the pages, or further adding the differential data. Further, such stored print data is print data which does not include information which becomes unnecessary in the relationship among pages of print data (association information of a not-extracted page). That is, it is assumed that multiple pieces of identification information that identify print page data from read data obtained through reading of multiple pages of prints are detected by the process up to step S300 or the process up to step S250 of FIG. 4. Then, out of the print page data of print data stored in the storage unit 33, the print page data which includes association information defining association with print page data from which identification information is detected and does not include association information defining association with the print page data from which no identification information is detected is a part of the newly generated print data.

The process of steps S260 to S290 substantially performs the process of steps S120 to S150 (FIG. 2).

That is, the control unit 31 generates identification information used for identifying print data stored in step S250 (step S260). In this case, the control unit 31 generates identification information used for identifying the print data in a unit of page of print data (print target page).

Next, the control unit 31 stores association relationship between the identification information generated in step S260 and the print data (each page) stored in step S250 is stored in the storage unit 33 (step S270). Furthermore, the control unit 31 embeds the identification information generated in step S260 in the print data stored in the step S250 (step S280). In this case, the control unit 31 embeds the associated identification information in data of each page of the print data.

In step S290, the control unit 31 transmits to the printer 20 the processed print data, that is, the print data in which identification information is embedded on a page basis in step S280.

The control unit 21 of the printer 20 receives print data transmitted from the server 30. That is, the control unit 21 receives the print data from the server 30 as a response to the read data and the copy instruction transmitted to the server 30. The control unit 21 then causes the printing unit 26 to perform printing in accordance with the received print data. That is, a printing step (step S30) is performed (see FIG. 5).

The under part in FIG. 5, prints PR11+DD, PR12, and PR22 output from the printer 20 through the printing step (step S30) are illustrated. The print PR11+DD is a copy result of the print PR11. That is, once the print PR11 is scanned by the reading unit 27 and the read data thereof is transmitted to the server 30, print data of the first page (P1) of the file F1 (print page data) is extracted from the storage unit 33 (step S214). The image of the handwritten character string 50 (differential data) is combined to the extracted print data to be a print target page (step S217), the print target page is printed by the printer 20, and as a result the print PR11+DD is obtained. In the print PR11+DD, while a portion where the handwritten character string 50 is reproduced is a copy result of the handwritten character string 50 read from the print PR11, the remaining portion is a print result of the print data stored in the storage unit 33 of the server 30. Therefore, a portion other than the reproduced handwritten character string 50 of the print PR11+DD has no deterioration of the image quality compared to the print PR11.

With respect to the prints PR12 and PR22 without the handwritten character string 50, there is no deterioration of the image quality at the copy process illustrated in FIG. 5. That is, once the prints PR12 and PR22 as documents are scanned by the reading unit 27 and the read data are transmitted to the server 30, print data of the second page (P2) of the file F1 and the second page (P2) of the file F2 (print page data) are extracted from the storage unit 33 in accordance with identification information PD01-02 and PD02-02 embedded in the prints PR12 and PR22 (step S214). The extracted print data are used as print target page without change (step S218), the print target page is printed by the printer 20, and as a result the prints PR12 and PR22 illustrated in the under part in FIG. 5 are obtained.

Within the prints PR11+DD, PR12, and PR22 illustrated in the under part in FIG. 5, identification information PD3-01, PD3-02, and PD3-03 included in a part of respective print results is depicted in a visible manner. However, the identification information PD3-01, PD3-02, and PD3-03 are printed on a printing medium in a form of an electronic watermark, a barcode, or the like in the actual implementation. Such identification information PD3-01, PD3-02, and PD3-03 is identification information generated and embedded (steps S260 to S280) for each page of print data stored in the server 30 in step S250.

Therefore, once a user causes the reading unit 27 to scan the prints PR11+DD, PR12, and PR22 illustrated in the under part in FIG. 5, print data identified by the identification information PD3-01, PD3-02, and PD3-03 embedded in the prints PR11+DD, PR12, and PR22 are extracted from the storage unit 33 in the server 30, and the extracted print data are printed by the printer 20. That is, copying without deterioration can be repeated.

According to the description of the above copying process (FIG. 4 to FIG. 6), when identification information is detected from read data obtained by reading a print, the control unit 21 and the printing unit 26 (print processing unit) of the printer 20 print the print data which is stored in the storage unit 33 and identified by the detected identification information. Further, when detecting identification information from read data obtained by reading a print, the control unit 31 of the server 30 (print control unit) causes the printer 20 to print the print data which is stored in the storage unit 33 and identified by the detected identification information.

### 4. Conclusion and Other Illustrations

The division of responsibilities of the server 30 and the printer 20 is not limited to the that described as above.

For example, a print control program 28 that is substantially the same as the print control program 34 is installed in the control unit 21 of the printer 20 (printing apparatus) (see FIG. 1). Further, the present embodiment includes a form in which the process which has been described as being performed by the control unit 31 of the server 30 is performed by the control unit 21 of the printer 20 in accordance with the print control program 28. That is, the print data generated by the client terminal 40 is transmitted to the printer 20 and stored in the storage unit 23 of the printer 20 (steps S100 and S110 of FIG. 2). The control unit 21 of the printer 20 then performs steps 5120 to 5140 and causes the printing unit 26 to print the processed print data (print data in which identification information is embedded in step S140). Furthermore, the control unit 21 can perform steps S210 to S280 and S300 of FIG. 4 in response to a user causing the reading unit 27 to scan a print as a document and acquiring read data of the document from the reading unit 27 and causes the printing unit 26 to print the processed print data (print data in which identification information is embedded in step S280).

Alternatively, the configuration including the server 30 and the printer 20 can be regarded as the printing apparatus of the invention.

According to the present embodiment described above, the system 10, the server 30, or the printer 20 stores, in the storage unit 33 or the storage unit 23, print data generated by a method other than reading of a print in advance and prints the print data and identification information used for identifying the print data on the same printing medium. Then, when the identification information is detected from read data obtained by reading a print, print data stored and identified by the detected identification information is printed. According to the above configuration, once a print on which the identification information is printed is scanned for copying, the identification information is detected from the scanned read data, print data identified by the identification information, that is, print data generated by a method other than reading of a print is printed. Therefore, a print without quality deterioration can be provided as a copy result to the user, compared to the related art in which data of a managed original document is the data which has been scanned and saved (which is already deteriorated data due to a scan).

According to the present embodiment, print data which is stored in the storage unit 33 or the storage unit 23 and identified by the detected identification information and data which is not included in the print data but included in the read data are printed on the same printing medium. According to the above configuration, once a print (for example, the print PR11) with an added handwritten character string 50 or the like is scanned for copying, stored print data and the added portion (differential data) are combined and printed. Therefore, the quality of a copy result including the added portion is improved.

Further, according to the present embodiment, new print data is generated in accordance with print page data identified by the detected identification information out of data for each page (print page data) of print data that are stored in the storage unit 33 or the storage unit 23 is generated (steps S210 to S250, FIG. 4), and the generated print data is printed. Therefore, when the reading unit 27 is caused to scan prints as a document which have been selected or rearranged by a user from various prints printed by the printer 20, new print data is generated and printed in accordance with the stored print data, and therefore a copy result intended by the user can be obtained at a high quality.

Further, according to the present embodiment, identification information used for identifying the generated print data is embedded in the generated print data in accordance with print data stored in the storage unit 33 or the storage unit 23, and the print data is printed (steps S260 to S290). According to the above configuration, when a print result of the generated print data (a copy result of a document for the user) is further copied, the print data can be extracted and printed in accordance with identification information, and thus there is no quality deterioration in a result including an added part such as the handwritten character string 50 even after copying is repeated.

Further, according to the present embodiment, by performing step S300, it is possible to save the print data generated as described above in a predetermined file form. It is further possible to transfer such print data (electronic file) to the outside.

Note that the process of generating identification information (steps S260 and S270) is not essential for obtaining print data generated as described above in accordance with print data stored in the storage unit 33 or the storage unit 23. Identification information has already been associated with a page of print data stored in step S250. Therefore, such identification information that has already been associated with may be embedded in print data stored in step S250 (step S280) and printed without performing steps S260 and S270. Specifically, the prints PR11+DD, PR12, and PR22 depicted in the under part in FIG. 5 may be printed together with the identification information PD1-01, PD1-02, and PD2-02 embedded in respective print page data in step S140 (FIG. 2) rather than with the identification information PD3-01, PD3-02, and PD3-03 newly generated in step S260.

When steps S260 and S270 are not performed as discussed above, however, the control unit 31 (or the control unit 21) stores in advance differential data associated with the added portion to the document (the handwritten character string 50) in association with identification information (identification information PD1-01) associated with print page data to be combined (print data of the first page (P1) of the file F1). Thereby, when a copy result obtained by scanning and printing a document with an added portion (the handwritten character string 50) is again scanned, a print in which stored print data and differential data are combined (a copy result) can be again obtained in accordance with identification information.

As a scheme for embedding identification information in print data, the scheme for embedding identification information converted in an electronic watermark, a barcode, or the like has been described. However, the identification information itself may be embedded in print data as visual information and printed together with the print data. That is, with respect to FIG. 3 and FIG. 5, while a character string as identification information (PD1-01 or the like) is depicted in a visual manner for the purpose of illustration, such a character string (PD01-01 or the like) may be printed as identification information on a printing medium in the actual implementation. In this case, when scanning a document and outputting read data, the reading unit 27 outputs the character string of the identification information obtained by using an optical text recognition function together with the read data. The control unit 31 (or the control unit 21) extracts print data from the storage unit 33 (or the storage unit 23) in accordance with the character data (identification information) obtained from the reading unit 27 together with read data.

Alternatively, required print data may be extracted by using a technology of image recognition and image search without using identification information that has been described above (without embedding identification information in print data). That is, the control unit 31 (or the control unit 21) searches print data stored in the storage unit 33 (or the storage unit 23) for an image which matches completely or matches at a high probability an image expressed by the read data obtained from the reading unit 27 and causes the printing unit 26 to print the print data extracted as a search result.

The entire disclosure of Japanese Patent Application No. 2017-051771, filed Mar. 16, 2017 is expressly incorporated by reference herein.

What is claimed is:

1. A printing apparatus comprising:
a storage unit that stores print data generated by a method other than reading of a print; and
a print processing unit that prints, on a single printing medium, the stored print data and identification information used for identifying the print data,
wherein, when the identification information from read data obtained by reading a print is detected, the print processing unit prints the print data stored in the storage unit and identified by the detected identification information.

2. The printing apparatus according to claim 1, wherein the print processing unit prints, on a single printing medium, the print data which is stored in the storage unit and identified by the detected identification information and data which is not included in the print data but is included in the read data.

3. The printing apparatus according to claim 1,
wherein the print data stored in the storage unit is formed of print page data that is data of each page, and
wherein the print processing unit prints, on a single printing medium, the print page data and identification information used for identifying the print page data and, when identification information used for identifying the print page data from the read data is detected, generates new print data in accordance with print page data identified by the detected identification information from print page data of the print data stored in the storage unit and prints the generated print data.

4. The printing apparatus according to claim 3,
wherein the print page data of the print data stored in the storage unit contains information defining an association with other print page data of the print data, and
wherein, when identification information identifying the print page data from the read data obtained by reading multiple pages of prints, the print processing unit generates as the new print data, out of the print page data of the print data, print page data which contains information defining an association with print page data from which the identification information is detected and does not contain information defining an association with print page data from which the identification information is not detected.

5. The printing apparatus according to claim 3, wherein the print processing unit prints, on a single printing medium, the generated print data and identification information used for identifying the generated print data.

6. The printing apparatus according to claim 3, wherein the print processing unit stores the generated print data in the storage unit.

7. A server comprising:
a storage unit that stores print data generated by a method other than reading of a print; and
a print control unit that causes a printing apparatus to perform a process of printing, on a single printing medium, the stored print data and identification information used for identifying the print data,
wherein, when the identification information from read data obtained by reading a print is detected, the print control unit causes the printing apparatus to print the print data stored in the storage unit and identified by the detected identification information.

8. A printing method comprising:
storing, in a storage unit, print data generated by a method other than reading of a print;
printing, on a single printing medium, the stored print data and identification information used for identifying the print data; and
when the identification information from read data obtained by reading a print is detected, printing the print data stored in the storage unit and identified by the detected identification information.

9. The printing method according to claim 8, wherein the print data which is stored in the storage unit and identified by the detected identification information and data which is not included in the print data but is included in the read data are printed on a single printing medium.

10. The printing method according to claim 8,
wherein the print data stored in the storage unit is formed of print page data that is data of each page, and
wherein the print page data and identification information used for identifying the print page data are printed on a single printing medium and, when identification information used for identifying the print page data from the read data is detected, new print data is generated in accordance with print page data identified by the detected identification information from print page data of the print data stored in the storage unit to print the generated print data.

11. The printing method according to claim 10,
wherein the print page data of the print data stored in the storage unit contains information defining an association with other print page data of the print data, and
wherein, when identification information identifying the print page data from the read data obtained by reading multiple pages of prints, print page data which contains information defining an association with print page data from which the identification information is detected and does not contain information defining an association with print page data from which the identification information is not detected is generated as the new print data from the print page data of the print data.

12. The printing method according to claim 10, wherein the generated print data and identification information used for identifying the generated print data is printed on a single printing medium.

13. The printing method according to claim 10, wherein the generated print data is stored in the storage unit.

14. A control method comprising:
storing, in a storage unit, print data generated by a method other than reading of a print;
causing a printing apparatus to perform a process of printing, on a single printing medium, the stored print data and identification information used for identifying the print data; and
when the identification information from read data obtained by reading a print is detected, causing the printing apparatus to print the print data stored in the storage unit and identified by the detected identification information.
